(19) United States
(12) Patent Application Publication
(10) Pub. No.: US 2006/0269328 A1
(43) Pub. Date: Nov. 30, 2006

(54) Image forming apparatus additionally using erasable toner

(75) Inventor: Norikazu Ochiai, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/138,313

(22) Filed: May 27, 2005

(51) Int. Cl. G03G 15/01

(52) U.S. Cl. 399/223; 399/227

(57) ABSTRACT

Around the photosensitive drum, there is an erasable developing unit arranged at a position separate from a revolver equipped with plural color developing units having permanent color toner. Toners scattering from the revolver are prevented from mixing in the color erasable developing unit and at the same time, permanent color toner are prevented from attached to a color erasable toner image in the color erasable toner mode. Thus, clean reusable paper without color toner remaining thereon is obtained when a toner image formed on a paper is erased.

### BACKGROUND OF THE INVENTION

1. Field of the Invention

This invention relates to an image forming apparatus which conducts the image forming using color erasable toner and the color image forming with permanent color toner and additionally using color erasable toner.

2. Description of the Related Art

In recent years, a large volume of paper is consumed with the increase of various informational data according to the development of the office automation. For the purpose to save paper resources, the paper recycling to reclaim used paper itself was so far executed. However, for the purpose of further promoting the environmental or resource protection, it is intended to achieve the practical paper reuse instead of recycle use of paper. The paper reuse is a technique to use same paper repeatedly according to a method to form images using color erasable toner or to erase toner fixed on paper by separating them mechanically or chemically or a method to react toner with heat or light or chemicals. For color erasable toner, exclusively use toner of which characteristics are entirely differing from permanent toner that are not color erasable are used.

In order to form images with erasable toner and color images with permanent color toner for this paper reuse, an apparatus for enabling it to install color erasable developing units at positions of permanent color developing units of a tandem type color image forming apparatus with magenta, cyan, yellow and black permanent color developing units arranged in a line is so far disclosed in the Japanese Patent Application Publication No. 2010-171198. This conventional color image forming apparatus executes “Normal Printing Mode” when an erasable developing unit is not installed and “Printing Mode by Erasable+Permanent Color Toners” or “Printing Mode by Erasable Toner Only” when an erasable developing unit is installed.

Because of being a tandem type, this conventional tandem type color image forming apparatus becomes large in size. Therefore, it is demanded to incorporate an erasable developing unit in a revolver type color image forming apparatus equipped with plural permanent color developing units to one revolving member.

However, when it is tried to install a color erasable developing unit to a revolving member jointly with a permanent color developing unit in a revolver type color image forming apparatus, a color erasable developing unit and a permanent color developing unit are positioned at places close to each other and scattering toner may possibly be mixed during the development. If permanent toner were attached to a color erasable developing unit as a result of color mixing of scattered toner, the permanent color toner may adhere in an image developed in color erasable toner. As a result, the permanent color toner attached is not erased and left in a developed image when erased by an erasing unit. Accordingly, when paper is reused repeated, the permanent toner attached will becomes highly visible as stains on a paper, paper quality is lowered and it becomes difficult to read a newly developed image.

In view of above, a revolver type color image forming apparatus is demanded, which is additionally using color erasable toner to provide reusable clean paper without stain and permanent color toner adhered on a color erasable developing unit when a color image is formed by permanent color toner or color erasable toner equipped with a color erasable developing unit.

### SUMMARY OF THE INVENTION

It is an object of this invention to provide a revolver type color image forming apparatus that is using erasable toner jointly with permanent color toner and can be downsized with a color erasable developing unit arranged at a position separated from a permanent color developing unit to prevent toner scattering from a permanent developing unit to adhere to a color erasable developing unit so as to obtain clean reusable paper without stains even when paper is reused repeatedly.

According to the embodiments of this invention, there is provided a color image forming apparatus additionally using color erasable toner, comprising an image carrier; a latent image forming unit to form an electrostatic latent image on the image carrier; a color erasable developing unit that is arranged near the image carrier and supplies color erasable toner to the electrostatic latent image; and a rotary developing unit that is arranged at a position near the image carrier but differing from the color erasable developing unit and supplies permanent color toner to the electrostatic latent image by rotating and supporting plural color developing units having different permanent color toner and by facing the color developing unit in a desired color.

### BRIEF DESCRIPTION OF THE DRAWINGS

FIG. 1 is a general construction diagram showing MFP (Multi-Functional Peripheral) in the embodiment of this invention;

FIG. 2 is a general explanatory diagram showing a color erasable developing unit and a revolver in the permanent toner mode in the embodiment of this invention;

FIG. 3 is a general explanatory diagram showing a color erasable developing unit and a revolver in the color erasable toner mode in the embodiment of this invention;

FIG. 4 is a general explanatory diagram showing the permanent color toner scattering by the rotation of a developing roller of the revolver in the embodiment of this invention;

FIG. 5 is a general explanatory diagram showing the arrangement of the color erasable developing unit to the revolver in the embodiment of this invention.

### DETAILED DESCRIPTION OF THE INVENTION

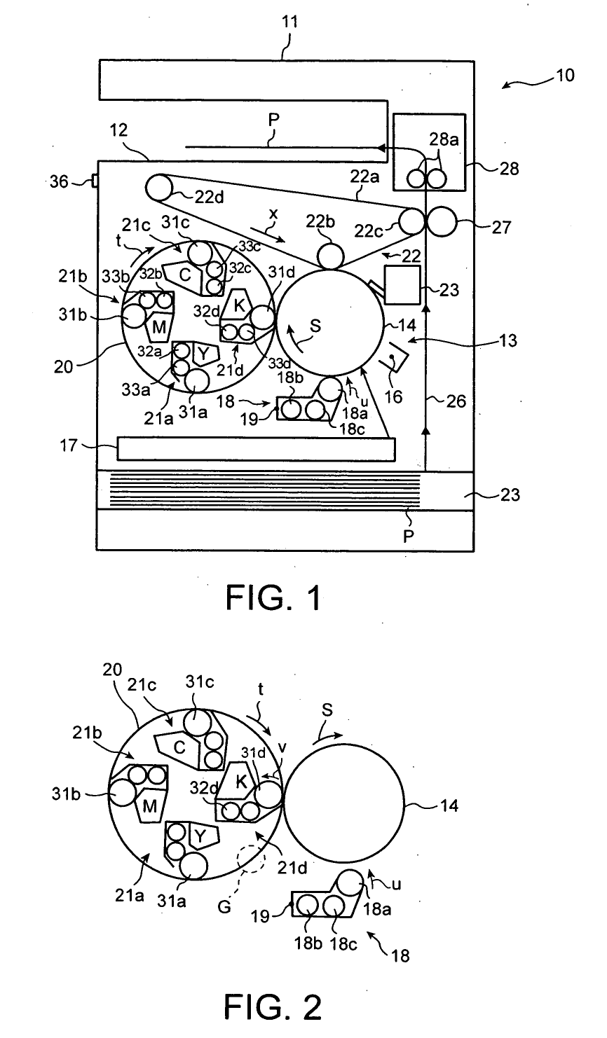

The embodiment of this invention will be explained in detail referring to the attached drawings. FIG. 1 is a general construction diagram showing a revolver type Multi-Functional Peripheral (hereinafter, abbreviated as MFP) 10. MPF 10 incorporates a scanner and a printer integrally to make it possible to input image data from a personal computer by a two-way interface such as a network line and also, image data from a FAX connected through a telephone line.

MPF 10 is equipped with a scanner unit 11 and an in-body discharging unit 12. A photosensitive drum 14 that is an image carrier is provided to a printer unit 11 of MFP 10. Around photosensitive drum 14, a charger 16 to uniformly charge photosensitive drum 14, and a laser writing unit 17 that is an exposure unit to expose charged photosensitive drum 14 are provided sequentially along the rotation in the arrow direction s. A latent image forming unit is composed of charger 16 and laser write unit 17.

Further, around photosensitive drum 14, there is provided a color erasable developing unit 18 that has erasable toner in the state to contact/separate with/from photosensitive drum 14. At the downstream side of erasable developing unit 18, a revolver 20 that is a rotary developing unit is provided. Revolver 20 is equipped with yellow (Y), magenta (M), cyan (c) and black (K) color developing units 21a to 21d having yellow (Y), magenta (M), cyan (C) and black (K) permanent color toner, respectively in the state movable in the arrow direction t. At the downstream side than revolver 20 around photosensitive drum 14, a middle transferring belt 22a, a primary transferring roller 22b, a back-up roller 22c, middle transferring unit 22 having a tension roller 22d and a cleaner 23 are arranged.

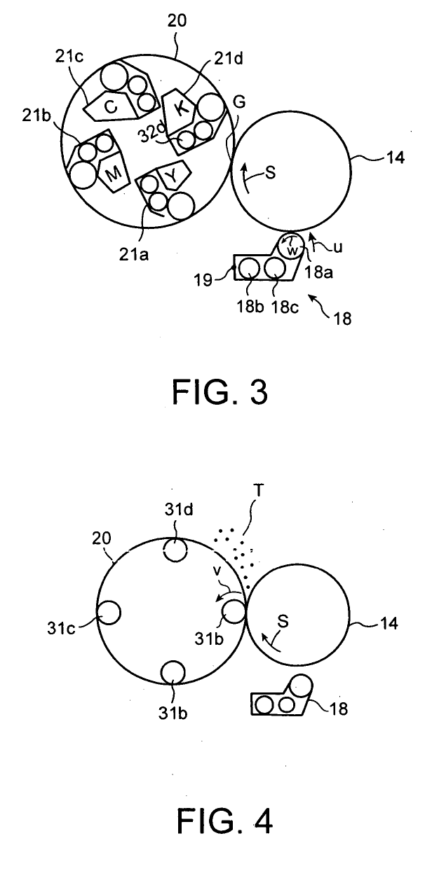

Erasable color developing unit 18 has a stirring mixer 18b and a conveying mixer 18c of a stirring/conveying unit under a developing roller 18a that is a supply unit. Developing roller 18a rotates in the arrow direction w when developing images. As shown in FIG. 2 and FIG. 3, color erasable developing unit 18 is provided rotatably by a cam mechanism (not shown), etc. with a side end 19 of stirring mixer 18b using as a supporting point, and is rotated in the arrow direction u to bring developing roller 18 to contact with or close to photosensitive drum 14 so as to develop an image in the forming of an image in color erasable toner. On the other hand, in the image forming with permanent color toner, color erasable developing unit 18 is turned in the direction reverse to the arrow direction u so as to separate developing roller 18a from photosensitive drum 14.

Color developing units 21a to 21d installed on revolver 20 have developing rollers 31a to 31d, stirring mixers 32a to 32d and conveying mixers 33a to 33d, respectively. Developing rollers 31a to 31d are turned in the arrow direction v when images are being developed. Permanent color toner T scattered by developing rollers 31a to 31d are much at the downstream side in the arrow direction v that is the rotating direction of developing rollers 31a to 31d in he developing area. So, in this embodiment, color erasable developing unit 18 is arranged at the upper stream side in the arrow direction v that is the rotating direction of developing rollers 31a to 31d of color developing units 21a to 21d in order to avoid the color mixing by the scattering permanent color toner T.

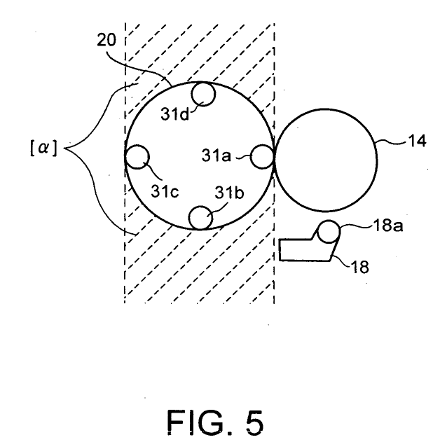

Further, developing roller 18a of color erasable developing unit 18 is arranged at the outside of the upper and lower areas [α] out of revolver 20 as shown in FIG. 5. Developing roller 18a is arranged by getting out of the upper and lower area [α] wherein permanent color toner much scatter in revolver 20 so as to prevent color mixing of permanent toner.

Further, color erasable developing unit 18 is arranged below photosensitive drum 14 so as to get away from the upper and lower area [α] as much as possible with stirring mixer 18b and conveying mixer 18c positioned at the side close to revolver 20. Accordingly, even when scattering toner 34 fell down, they do not attach to developing roller 18a of color erasable developing unit 18 at the time of image development by revolver 20.

The image development by color erasable developing unit 18 or by revolver 20 is switched by a changeover switch 36 that is a switching device provided to MFP 10 or by the input from a control panel of a terminal equipment connected through the network line.

Under printer unit 13, a cassette 24 housing paper P is provided. Along a conveying path 26 of paper P taken out from paper supply cassette 24, a secondary transferring roller 27 and a fixing unit 28 are provided. Middle transfer belt 22a is brought in contact with photosensitive drum 14 at a position supported by primary transferring roller 22b and a toner image on photosensitive drum 14 is primarily transferred thereon. Then, middle transfer belt 22a is opposed to secondary transferring roller 27 at a position supported by back-up roller 22c and secondarily transfers a toner image on a paper P that is passing between back-up roller 22c and secondary transferring roller 27. Fixing unit 28 has a fixing roller pair 28a.

Next, the image forming process by MFP 10 will be explained. When, for example, a toner image is formed with permanent color toner using color developing units 21a to 21d installed on revolver 20, MFP 10 is switched to the permanent color toner mode by changeover switch 36. Thus, color erasable developing unit 18 is rotated in the direction reverse to the arrow direction u and developing roller 18a is moved away from photosensitive drum 14 as shown in FIG. 2. Photosensitive drum 14 is charged uniformly by charger 16 with the rotation in the arrow direction s, applied with laser beam corresponding to a black image signal by laser writing unit 17 and a black electrostatic latent image is formed thereon and reaches revolver 20. In revolver 20, black (K) developing roller 31d that rotates in the arrow direction v is faced to photosensitive drum 14 and supplying a black permanent toner to the electrostatic latent image, forms a black toner image.

Then, the black toner image on photosensitive drum 14 is primarily transferred on middle transfer belt 22a that is rotated in the arrow direction x by bias applied from primary transferring roller 22b. Residual toner left on photosensitive drum 14 is removed by cleaner 23. Thereafter, cyan (C), magenta (M) and yellow (Y) toner images are formed on photosensitive drum 14 and primarily transferred on middle transfer belt 21 in the same manner as that in the black toner image forming process described above, and a full-color toner image with black (K), cyan (C), magenta (M) and yellow (Y) images superposed is formed on middle transfer belt 21a. While revolver 20 is rotated in the arrow direction t and opposes cyan (C) developing roller 31c, magenta (M) developing roller 31b and yellow (Y) developing roller 31a to photosensitive drum 14 sequentially.

Thereafter, the full-color toner image on middle transfer belt 21a is applied with bias from secondary transferring roller 27 and secondarily transferred on paper P collectively. The full-color toner image on paper P is fixed by fixing roller 28a and the paper is discharged into discharging unit 12.

When an image is forming by this revolver 20, permanent color toner are scattered from color developing units 21a to 21d. However, color erasable developing unit 18 has stirring mixer 18b and conveying mixer 18c at the side close to revolver 20, and is arranged in the direction to get away from revolver 20 as much as possible at a place away from the upper and lower areas [α] revolver 20. Further, color erasable developing unit 18 is arranged at the upper stream side wherein the scattering of permanent color toner is less in the arrow direction v that is the rotating direction of developing rollers 31a to 31d of color developing units 21a to 21d. Accordingly, permanent color toner will not mix in color erasable developing unit 18.

When a toner image is formed in color erasable toner using color erasable developing unit 18, MFP 10 is switched to the color erasable toner mode by changeover switch 36. Thus, color erasable developing unit 18 is rotated in the arrow direction u and developing roller 18a is brought in contact with or close to photosensitive drum 14. Further, revolver 20 rests at a position wherein a gap G between yellow color developing unit 21a and black color developing unit 21d is faced to photosensitive drum 14.

Photosensitive drum 14 is uniformly charged by charger 16 following the rotation in the arrow direction s, applied with laser beam corresponding to a color erasable toner image signal by laser writing unit 17, and a color erasable toner electrostatic latent image is formed thereon and reaches color erasable developing unit 18. In color erasable developing unit 18, developing roller 18a rotating in the arrow direction w faces to photosensitive drum 14, supplies color erasable toner to the electrostatic latent image and forms an image in color erasable toner.

Then, the toner image formed on photosensitive drum 14 is primarily transferred on middle transferring belt 22a at the position of primary transferring roller 22b and further, when reaching the secondary transferring roller 27, secondarily transferred on paper P. After transferring, residual toner is cleaned by cleaner 23. The color erasable toner image transferred on the paper P is fixed by fixing roller 28a and the paper P is discharged in the discharging unit 12.

In the image forming with color erasable toner, revolver 20 is arranged at the downstream in the rotating direction of photosensitive drum 14 by color erasable developing unit 18 and furthermore, the gap G between yellow color developing unit 21a and black color developing unit 21d is facing to photosensitive drum 14. Accordingly, it is possible to prevent the permanent toner from attaching to photosensitive drum 14 as a covering toner and from mixing in the formed color erasable toner image.

When a color erasable toner image formed on paper P by this MFP 10 is erased by any color erasing unit for reusing paper after completing the use, permanent color toner adhered on paper after erasing a toner image is observed and clean reuse paper without any attached matter is obtained and paper can be reused repeatedly.

According to this embodiment, color erasable developing unit 18 is arranged at a position separating from revolver 20 equipped with color developing units 21a to 21d having permanent color toner around photosensitive drum 14. It is therefore possible to prevent the mixing of permanent color toner into color erasable developing unit 18 irrespective of toner scattering from revolver 20. In addition, it is also possible to prevent the mixing of permanent color toner by the scattering toner certainly because color erasable developing unit 18 is provided with stirring mixer 18b and conveying mixer 18c at the side close to revolver 20 and is arranged at a position out of the upper and lower area [α] of revolver 20 so that developing roller 18 is arranged in the direction getting away from revolver as much as possible and color erasable developing unit 18 is arranged at the side of less scattering toner of the upper stream side in the rotating direction of developing rollers 31a to 31d in the rotting direction of photosensitive drum 14.

Further, from the fact that revolver 20 is arranged at the downstream lower the color erasable developing unit 18 in the rotating direction of photosensitive drum 14 around photosensitive drum 14 and that revolver 20 faces the gap G between yellow color developing unit 21a and black color developing unit 21d to photosensitive drum 14, it is possible to prevent permanent color toner from attaching to photosensitive drum 13 in the color erasable toner mode certainly. Accordingly, when forming a toner image in color erasable toner, permanent color toner do not mix in a toner image and furthermore, when a toner image on paper P is erased after using the image data, permanent color toner are not erased and remain thereon, reuse paper with color erased clearly is obtained, and paper can be used repeatedly.

Further, this invention is not restricted to the embodiment described above but can be modified variously within its scope; for example, the arranging position of the color erasable developing unit is not limited and can be a position where the color erasable toner do not mix with the permanent color toner. Further, the color image forming apparatus can be a printer or a single unit of copier. In addition, the number of color developing units that are installed in a revolver of the color image forming apparatus or toner colors, etc. are not restricted.

As described above in detail, according to this invention, a color erasable developing unit is arranged at a position separating from the revolver. Thus, it is possible to prevent toner scattering from the revolver in the color toner image forming from attaching to the color erasable developing unit. In addition, it is also possible to prevent permanent color toner from attaching to a color erasable toner image when forming a color erasable toner image. Accordingly, the mixing of permanent color toner into a color erasable toner image formed on paper P can be prevented surely and a clean reusable paper without permanent color toner not erased and remaining is obtained after using the formed image.

What is claimed is:

1. A color image forming apparatus additionally using color erasable toner, comprising:
an image carrier;
a latent image forming unit to form an electrostatic latent image on the image carrier;
a color erasable developing unit that is arranged near the image carrier and supplies color erasable toner to the electrostatic latent image; and
a rotary developing unit that is arranged at a position near the image carrier but differing from the color erasable developing unit and supplies permanent color toner to the electrostatic latent image by rotating and supporting plural color developing units having different permanent color toner and by facing the color developing unit in a desired color.

2. The color image forming apparatus as claimed in claim 1, wherein the color erasable developing unit is arranged at the upper stream in the moving direction of the image carrier than the rotary developing unit.

3. The color image forming apparatus as claimed in claim 1, wherein the color erasable developing unit has a supply member to supply color erasable toner to the image carrier and a stirring member to stir and convey color erasable toner to the supply member, the stirring member being arranged near the image carrier at the side to face the rotary developing unit.

4. The color image forming apparatus as claimed in claim 1, wherein the rotary developing unit faces a gap between the plural color developing units to the image carrier when the color erasable toner is supplied by the erasable toner developing unit.

5. The color image forming apparatus as claimed in claim 1 further comprising a switching device to change over the color erasable toner supply by the color erasable developing unit or the permanent color toner supply by the rotary developing unit.

6. The color image forming apparatus as claimed in claim 1, wherein the image carrier is a photosensitive drum and the color erasable developing unit is positioned at the upper stream side against the rotating direction of the developing roller of the color developing unit.

7. The color image forming apparatus as claimed in claim 1, wherein the developing roller of the color erasable developing unit is positioned at the outside of the upper and lower area of the rotary developing unit.

8. A color image forming apparatus additionally using color erasable toner, comprising:
an image carrying means for being formed a developed image by color erasable toner or permanent color toner;
a latent image forming means for forming an electrostatic latent image on the image carrying means;
a color erasable developing means for supplying the color erasable toner to the electrostatic latent image; and
a rotary developing means for supporting rotatably plural coler developing means having different permanent color toner and for supplying the permanent color toner to the electrostatic latent image at a position differing from the color erasable developing means.

9. The color image forming apparatus as claimed in claim 8, wherein the erasable developing means is positioned at the upper stream side in the moving direction of the image carrying means than the rotary developing means.

10. The color image forming apparatus as claimed in claim 8, wherein the color erasable developing means has supply means for supplying the color erasable toner to the image carrying means and stirring means for stiring and conveying the color erasable toner to the color erasable toner supply means, and is arranged at a position near the image carrier so that the stirring means comes to the side close to the rotary developing means.

11. The color image forming apparatus as claimed in claim 8, wherein the rotary developing means brings a gap between the plural color developing means to the image carrying means when the color erasable toner are supplied by the color erasable developing means.

12. The color image forming apparatus as claimed in claim 8 further comprising switching means for changing over the color erasable toner supply by the color erasable developing means or the permanent color toner supply by the rotary developing means.

13. The color image forming apparatus as claimed in claim 8, wherein the image carrying means has a drum shape and the color erasable developing means is positioned at the upper stream side in the rotating direction of the developing roller of the color developing means in the rotating direction of the image carrying means.

14. The color image forming apparatus as claimed in claim 8, wherein the developing roller of the color erasable developing means is positioned at the outside of the upper and lower area of the rotating developing means.

15. A color image forming apparatus additionally using color erasable toner comprising:
a photosensitive drum;
a latent image forming unit that has a charger and an exposing unit and forms an electrostatic latent image on the photosensitive drum;
a color erasable developing unit that is arranged near the photosensitive drum and supplies color erasable toner to the electrostatic latent image; and
a revolver that is arranged at a position near the photosensitive drum differing from the color erasable developing unit and supplies the permanent color toner to the electrostatic latent image by rotatably supporting plural color developing units having different permanent color toner and facing the color developing units in desired colors to the photosensitive drum.

16. The color image forming apparatus as claimed in claim 15, wherein the color erasable developing unit is arranged at the upper stream side in the rotating direction of the photosensitive drum than the rotary developing unit.

17. The color image forming apparatus as claimed in claim 15, wherein the color erasable developing unit has a developing roller to supply the color erasable toner to the photosensitive drum and a stirring auger to stir and convey the color erasable toner to the developing roller and is arranged near the photosensitive drum with the stirring auger positioned at the side near the revolver.

18. The color image forming apparatus as claimed in claim 15, wherein the revolver brings a gap between the plural color developing units to the photosensitive drum when supplying the color erasable toner by the color erasable developing unit.

19. The color image forming apparatus as claimed in claim 15, wherein the color erasable developing unit is positioned at the upper stream side against the rotating direction of the developing roller of the color developing unit in the rotating direction of the photosensitive drum.

20. The color image forming apparatus as claimed in claim 15, wherein the developing roller of the color erasable developing unit is positioned at the outside of the upper and lower area of the revolver.
